(19) United States
(12) Patent Application Publication
(10) Pub. No.: US 2026/0029511 A1
(43) Pub. Date: Jan. 29, 2026

(54) TWO-STAGE LINE OF SIGHT (LOS)/NON-LINE OF SIGHT (NLOS) CLASSIFIER

(71) Applicant: STMicroelectronics International N.V., Geneva (CH)

(72) Inventors: Julien DUPEYROUX, La Buisse (FR); Fabien JAMMES, Brison St. Innocent (FR)

(73) Assignee: STMicroelectronics International N.V., Geneva (CH)

(21) Appl. No.: 19/271,282

(22) Filed: Jul. 16, 2025

(30) Foreign Application Priority Data
Jul. 26, 2024 (FR) FR2408344

(51) Int. Cl. G01S 7/41

(52) U.S. Cl. CPC G01S 7/417; G01S 7/411

(57) ABSTRACT

A multi-environment LOS/NLOS classifier for a UWB ranging device includes an environment classifier and an LOS/NLOS classifier. The environment classifier uses a convolutional neural network (CNN) fed by channel impulse response (CIR) of a received radio signal, cascaded with a multilayer perceptron (MLP) fed by a set of statistical characteristics extracted from the CIR. The environment classifier provides an environment class to the LOS/NLOS classifier, typically an MLP also receiving as input the output of the CNN and another set of statistical and physical characteristics extracted from the CIR. The environment class may form a model input to the MLP operating as an LOS/NLOS classifier, or it may be a modulation parameter of the MLP, typically a bias or weight modification factor of the MLP.

### PRIORITY CLAIM

This application claims the priority benefit of French Application for Patent No. FR2408344, filed on Jul. 26, 2024, the content of which is hereby incorporated by reference in its entirety to the maximum extent allowable by law.

### TECHNICAL FIELD

Embodiments and implementations relate to the field of wireless communications and, more specifically, to determining line-of-sight (or LOS) or non-line-of-sight (or NLOS) in wireless environments, such as ultra-wideband (UWB) environments.

### BACKGROUND

Ultra-wideband (UWB) data transmission uses very short radio frequency pulses (often less than a nanosecond), over a large bandwidth of the order of 500 MHz or more. Ultra-wideband UWB communications operate at frequencies ranging between 3.1 GHz and 10.6 GHz, for example in a first band between 3.1 GHz and 4.8 GHz or a second band between 6 GHz and 8.5 GHz.

One of the main applications of UWB technology is measuring distance and locating mobile devices. Such an application can be used to set up a wide range of services.

One condition for obtaining accurate measurements and locations is to know whether the path of a radio signal between the transmitter (typically UWB network equipment known as the “anchor”) and the receiver of the radio measurement signal (typically a mobile device called the “tag”) is a straight unobstructed line, referred to as LOS for line-of-sight, or if the path of the radio signal is not a straight unobstructed line, referred to as NLOS for non-line-of-sight.

More generally, absence of line-of-sight (NLOS) corresponds to any configuration in which the direct line connecting the transmitter to the receiver passes an obstacle, the physical properties of which are likely to delay the signals, distort them or block them completely.

In addition, identifying line-of-sight or non-line-of-sight, hereinafter LOS/NLOS identification, is a key issue as it enables distance measurement errors to be mitigated or corrected or measurements to be rejected.

LOS/NLOS identification can be performed using UWB channel measurements, such as the channel impulse response (CIR). LOS/NLOS identification methods detect, in particular, channel characteristics by analyzing the CIR, such as amplitude reduction or the extent of a delay.

It is known to use LOS/NLOS classification models or classifiers which use artificial intelligence such as machine learning. These models have, for example, learned to recognize characteristics specific to NLOS paths within the CIR, given the environmental noise.

However, NLOS paths and environmental noise vary hugely from one environment to another, for example between indoor offices, warehouses and/or an outdoor car park.

This is why it is known to date to use specialized classification models, such as models that are specific to the environment in question.

A significant degradation in the performance of the same model is observed when it is applied to another environment.

Moreover, attempts to obtain a multi-environment classification model have proven futile, with mediocre performance.

Reference is made to Park, et al., “Improving Deep Learning-Based UWB LOS/NLOS Identification with Transfer Learning: An Empirical Approach,” Electronics, 2020, which proposes using existing LOS/NLOS classification/identification models in an unknown environment, updating them by transfer learning to adapt them to the new environment with little data and a short learning time.

However, the fact remains that new learning and therefore a new model are required for each distinct environment if a good level of performance is to be maintained.

This situation is unsatisfactory given the reality of the desired uses and applications in which the devices pass through various types of environment as they progress. This is the case, for example, in automotive applications with key tracking (UWB tag) to automatically unlock or lock the vehicle door depending on the user's distance, even though the user may be outside, in their garage, in the rooms of their home, etc.

Other applications relate to assistance robots in industry which face very varied environments; last-mile delivery robots in urban areas; crawlers, for example, for locating and/or mapping underwater areas.

There is therefore a need for improved multi-environment LOS/NLOS classification which provides robust results.

### SUMMARY

In an embodiment, the classification model is modulated by environmental information obtained dynamically from the current use.

In addition, a multi-environment classification model can be trained and used.

According to one aspect, an electronic device is thus proposed comprising: a communication circuit configured to receive a radio signal and obtain a channel impulse response (CIR) from the radio signal; a pre-classification circuit configured to classify an environment of the electronic device receiving the radio signal; and an artificial intelligence (AI) LOS/NLOS classification model configured to determine line-of-sight (LOS) or non-line-of-sight (NLOS) depending on the CIR and the environment class determined by the pre-classification circuit. AI models have the advantage of enabling machine learning to achieve naturally good performance.

By modulating the machine learning model according to the environment class determined, a model is obtained that has good LOS/NLOS classification performance while allowing generalization to a plurality of environmental scenarios.

Indeed, it follows from this architecture that the environment class can be included in the training data, and that consequently the classification model also learns the environment and becomes sensitive to it.

The radio signal is, for example, an ultra-wideband (UWB) signal, typically used in distance measurement and location applications.

According to another aspect, a communication method is proposed comprising the following steps, in an electronic device: obtaining a channel impulse response (CIR) from a received radio signal; determining an environment class classifying an environment of the electronic device receiving the radio signal; and using a classification model to determine line-of-sight (LOS) or non-line-of-sight (NLOS) depending on the CIR and the environment class determined.

Optional features of embodiments are defined below with reference to the device, while they can be transposed into method features.

According to one embodiment, the pre-classification circuit comprises an AI environment classification model configured to determine an environment class of the electronic device from the CIR. This provision advantageously makes it possible to use only the communication circuit and the same measure (the CIR) for all classifications.

However, it is possible, alternatively, to use additional means other than an AI model. For example, a camera coupled to a processor identifying environmental characteristics may be used.

In one embodiment, the pre-classification circuit comprises a convolutional neural network (CNN) cascaded with an AI environment classification model for the electronic device configured to determine an environment class, the CNN receiving the CIR as input. This provision makes it possible to benefit from high performance of the CNNs to identify geometric characteristics in the CIR for high-quality environment classification.

According to one specific feature, the AI environment classification model receives, in addition to the output of the CNN, a first set of characteristics extracted from the CIR. This provision makes it possible to take advantage of known, easily identifiable mathematical characteristics when classifying environments. The first set of characteristics for an environment classification typically comprises characteristics of a statistical nature (from the CIR), such as mean, standard deviation, skewness coefficient, kurtosis coefficient, signal-to-noise ratio, etc.

According to one specific feature, the CNN and the AI environment classification model are trained jointly, using a dataset labelling CIRs with environment classes. Joint learning means that the outputs of the CNN are not fixed in advance and are therefore learned. This provision consequently provides greater flexibility in the definition (by learning) of the outputs of the CNN, and therefore better environment classification results.

In one embodiment, the LOS/NLOS classification model receives as input the output of the CNN and a second set of characteristics extracted from the CIR. This provision makes it possible to take advantage of known, easily identifiable mathematical characteristics during LOS/NLOS classification. The second set of characteristics for an LOS/NLOS classification typically comprises characteristics of a statistical nature and characteristics of a physical nature (on the CIR), such as total energy, peaks, rising edge slope, etc.

According to another specific feature, the LOS/NLOS classification model is trained once the CNN and the AI environment classification model have been trained.

In one embodiment, the environment class determined is provided as input to the AI LOS/NLOS classification model. This provision is advantageously applicable to any type of machine learning classifier, whether it is a neural network, k-nearest neighbors, support vector machine, decision tree, etc. It enables in particular seamless integration into the chosen classifier.

In another embodiment, the environment class determined is provided as modulation parameter for the AI LOS/NLOS classification model, for example as a bias or as a factor for modifying the weight of one or more connections (typically of all connections) in a neural network forming the AI LOS/NLOS classification model.

This configuration avoids the need to add an input to the network, which on the one hand reduces the size of the neural network by comparison, and on the other hand makes learning faster, and therefore converges more quickly. Finally, the risk of overfitting is reduced.

### BRIEF DESCRIPTION OF THE FIGURES

Other advantages and features of the invention will become apparent upon examining the detailed description of non-limiting embodiments and implementations, and from the accompanying drawings, wherein:

FIG. 1 shows a system in which two devices communicate with one another, typically for a ranging application;

FIG. 2 is a block diagram of an electronic device;

FIG. 3 is a block diagram of a classification circuit;

FIG. 4 is a further block diagram of the classification circuit;

FIG. 5 is a flowchart showing steps of a communication method; and

FIG. 6 shows the hardware architecture for a device.

### DETAILED DESCRIPTION

Ultra-wideband (UWB) technology has many applications in various fields relating to measuring distance and/or locating mobile objects.

The standards IEEE 802.15.4 and 802.15.4z provide various details on UWB communication protocols. Variations of UWB communication protocols are proposed for various ranging services, such as the FiRa protocol (meaning fine ranging) described through a plurality of technical specifications including the following: “FIRA MEDIUM ACCESS CONTROL (MAC) TECHNICAL SPECIFICATION”, VERSION 2.0.0.

Other communication protocols may use the UWB frequency, in particular the standard IEEE 802.11 ax (and the following).

The issue of LOS/NLOS classification, meaning the identification of whether the path of a radio signal is an unobstructed straight line, in other words line-of-sight (or LOS), or is not an unobstructed straight line, in other words non-line-of-sight (or NLOS), is not specific to UWB technology but rather to any radio frequency.

However, UWB technology with its many ranging applications is fertile ground for implementing high-precision LOS/NLOS classification.

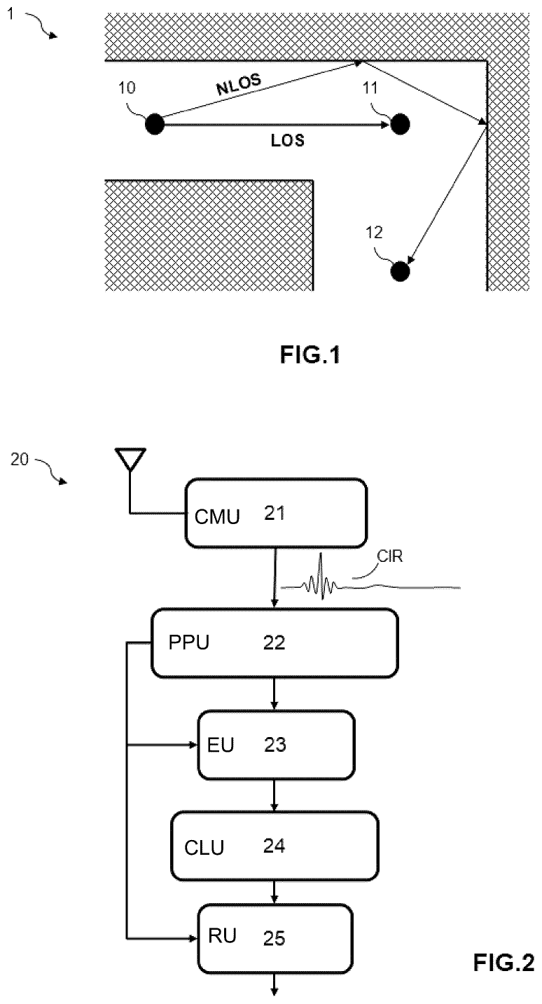

FIG. 1 shows a system UWB 1 in which two UWB devices communicate with one another, typically for a ranging application. The system UWB 1 can be a two-way ranging system FiRa.

A first device FiRa 10, called “controller”, defines and controls the ranging functions by sending a control message, and a second device FiRa 11, 12, called “controllee”, uses the ranging functions as configured by the control message of the controller in a one-to-one mode. A greater number of controllees may be present in a “one-to-many” ranging mode.

In a UWB ranging application, when the first device 10 transmits a high-frequency signal in the direction of the second device 11 or 12, the exact position of the second device 11, 12 can be calculated by measuring the time-of-flight of this signal.

In an environment where no obstacle hinders the communication between the first device 10 and the second device 11, there is a line-of-sight situation LOS in which the high-frequency signals are directly transmitted from one to the other.

In an environment where an obstacle hinders the communication between the first device 10 and the second device 12, the high-frequency signal is reflected off one or more surfaces to reach the second device 12.

In radio communications, in particular UWB, it is important to precisely identify LOS and NLOS situation in order, for example, to compensate for ranging measurement errors.

FIG. 2 shows an electronic device 20 participating in ranging operations. It may be any one of the devices 10, 11, 12 shown in FIG. 1.

The device 20 has a communication circuit (CMU) 21, a pre-processing circuit (PPU) 22, an extraction circuit (EU) 23, a classification circuit (CLU) 24 and a ranging circuit (RU) 25.

The communication circuit 21, connected to one or more antennas, is typically a UWB transmitter-receiver circuit made up of a transmitter part and a receiver part. The focus here is on the receiver part, which is responsible for receiving the radio signals of a UWB frame transmitted by another device. A UWB frame is generally made up of pulses, the shape of which is designed for a ranging application.

The receiving antenna picks up the UWB radio signal, which, after processing (not shown) such as bandpass filter, amplification, etc., is converted into a channel impulse response (CIR). The CIR can be constructed by accumulating elementary (low-energy) CIRs over the multiple pulses forming the UWB frame, in order to obtain a significant CIR. Each elementary CIR corresponds to the response of a single pulse of the UWB frame sent. The significant CIR corresponds to the aggregated responses of all the pulses forming the UWB frame transmitted.

The pre-processing circuit 22 carries out pre-processing (optional) of the CIR to improve the ranging performance by the ranging circuit 25. By way of example, filtering operations to denoise the signal or eliminate outliers, sub-sampling and cropping may be applied.

The processed CIR is then used by the ranging circuit 25 to determine a time-of-flight or ToF of the signal and to deduce, for example, a distance from or location of the device 20 or device with which it is interacting. Ranging calculations are known to a person skilled in the art and are therefore not described in more detail here.

However, these ranging calculations comprise correction operations which may compensate for the times-of-flight depending on whether the communication situation is LOS or NLOS.

In addition, the CIR is used by the extraction circuit 23 to extract characteristics of interest, in particular statistical characteristics of the CIR, such as: the signal mean, standard deviation, a skewness coefficient S, a kurtosis coefficient K, a signal to noise ratio, average delay (average delay of all the paths identified on the CIR), delay dispersion, etc., and physical characteristics of the CIR, such as: total energy, maximum amplitude of the signal (main peak), the rising edge slope (or rise time) for the peaks of the CIR, normalized energy of the most robust path, the index of the first sample of the CIR significantly above the noise, etc.

These characteristics are used by the classification circuit 24, with the CIR, to determine the type of situation encountered, in other words to make the LOS or NLOS determination. The LOS or NLOS type is indicated to the ranging circuit 25 so that the appropriate adjustments can be made.

It is known to use machine learning classifiers (such as AI models) as classification circuits 24. However, in order to be robust, these classifiers are trained with sets of data specific to a particular environment.

Environment is understood to be the context in which the measurements are taken. The environment is defined by all the elements which disturb or interact with the radio signals, whether obstacles, reflection surfaces or the absence of such elements. These elements vary greatly from one environment to another, for example indoor offices, warehouses, an outdoor car park.

The environment in which the UWB system operates has a considerable influence not only on its performance, but also on the characteristics of the CIR itself. This is why the classifiers are trained with sets of data specific to their application environment.

However, the devices 10, 11, 12 may be required to progress in different environments during the same operation. For example, operations to map a site may involve a mapping robot taking measurements in indoor and outdoor environments with very different characteristics.

The use of a single classifier would be advantageous in the sense that the required memory space would be compatible with microprocessors installed in robots.

In this context, a new type of classifier is proposed with two stages, one to determine the type of environment and the other, a LOS/NLOS classifier, depending on the type of environment determined and trained with this information.

A device 10, 11, 12 thus has, in addition to the communication circuit 21 configured to receive the radio signal and obtain the CIR from the radio signal, a pre-classification circuit 24 configured to classify an environment of the electronic device receiving the radio signal, and an LOS/NLOS classifier-typically an artificial intelligence (AI) model-configured to determine line-of-sight (LOS) or non-line-of-sight (NLOS) depending on the CIR and the environment class determined by the pre-classification circuit.

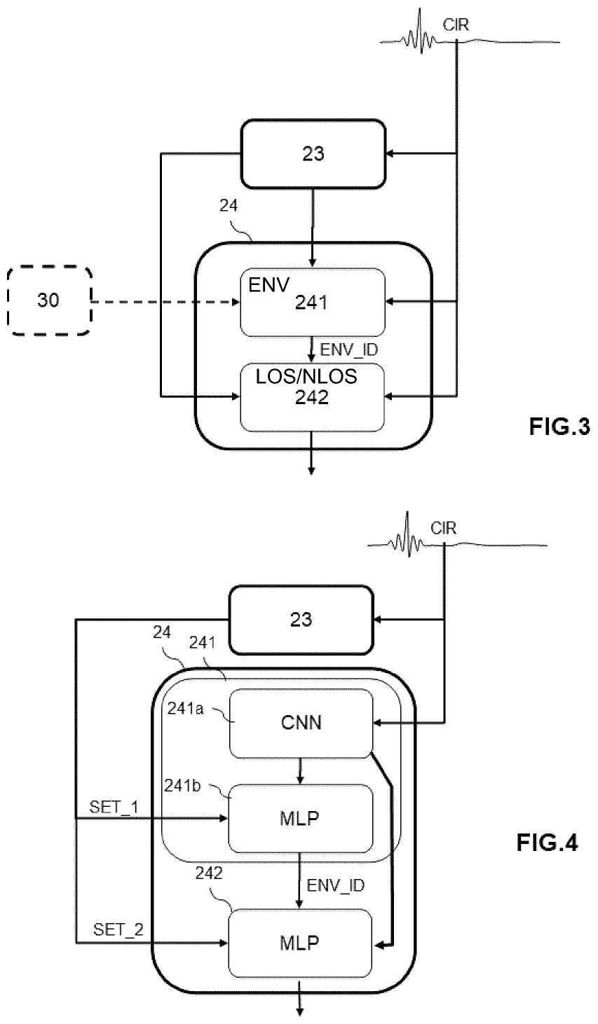

FIG. 3 shows a classification circuit 24 according to embodiments. Although the classification circuit 24 can only receive the CIR as input, the figure envisages a configuration with the extraction circuit 23 to provide the classification circuit 24 with statistical and physical characteristics already extracted from the CIR, in addition to the CIR.

The figure shows the cascading of a first environment (ENV) classifier 241 with a second LOS/NLOS classifier 242, in which the environment class ENV_ID determined by the first classifier 241 is used as input to the second classifier 242. The classifier 24 thus has two stages.

The environment classifier 241 is typically an AI model configured (and trained) to determine an environment class of the electronic device from the CIR, directly from the CIR and/or using characteristics extracted from the CIR by the extraction circuit 23. The environment classifier 241 is used, in particular, to pre-classify the UWB radio signals with regard to the environment in which the measurement device is progressing.

In embodiments, the environment classes may be limited in number for very different contexts, corresponding, for example, to scenarios in which very different noise levels can be expected, due, for example, to multiple reflections, and distinct probabilities of distortion and/or occlusion of the signal. These pre-defined environment classes can be implemented with AI classification models trained in a supervised manner or with conventional mathematical models.

In other embodiments, no environment class is pre-defined, said environment classes being determined by the AI classification model trained in an unsupervised manner. These other embodiments have the advantage of extending the environment classes beyond what humans can perceive from CIRs, and of finding the classes that best modulate the LOS/NLOS classifier 242.

By way of example, the following environment classes can be pre-defined: class 1: outside, open-air with little noise (for example, typically, a wasteland or a field); class 2: outside, open-air with high noise level (for example, typically, an urban city center, a car park, a residential/built-up area); class 3: inside, industrial type (for example, typically, a warehouse, a manufacturing area or facility, an underground car park); class 4: inside, public space (for example, typically, an open space, a museum, a shopping center); class 5: inside, private space (for example, typically, the inside of a house.

Alternatively, a smaller number of classes may be used as part of specific applications. For example, the following classes may be defined in the automotive field: class 1: inside, private space, for example a private garage; class 2: inside, industrial space, for example a car garage; and class 3: outside, open-air with high noise level.

Of course, a different number of classes may be envisaged.

Furthermore, although the class identifier ENV_ID can be a whole number as indicated above, in some embodiments, it may be a likelihood (possibly logarithmic) value or a percentage. Such non-integer values enable, in particular, more accurate modulation of the second classifier 242.

The AI environment classification model can be any type of traditional classifier using machine learning, such as a KNN (k-nearest neighbors) algorithm, a Ridge classifier, a decision tree, a random forest algorithm, an AdaBoost algorithm, a Gaussian Naive Bayes classifier. Alternatively, it can be implemented using a slow progression neural network model, for example a multilayer perceptron (MLP), a convolutional neural network (CNN), a recurrent neural network (RNN) or any combination of these standard models.

As an alternative to using an AI model, conventional sensors 30 for determining the environment may be used, as shown by dashed lines in the figure. For example, a camera associated with a processor identifying environmental characteristics may be used to obtain an environment class.

The LOS/NLOS classifier 242 therefore receives the environment class ENV_ID determined by the environment classifier 241. The LOS/NLOS classifier 242 is configured (trained) to determine an LOS situation or an NLOS situation depending on the CIR (directly and/or via extracted characteristics) and the environment class ENV_ID.

In a manner similar to the first classifier 241, the LOS/NLOS classifier 242 can be any type of traditional classifier using machine learning, such as a KNN (k-nearest neighbors) algorithm, a Ridge classifier, a decision tree, a random forest algorithm, an AdaBoost algorithm, a Gaussian Naive Bayes classifier. Alternatively, it can be implemented using a slow progression neural network model, for example a multilayer perceptron (MLP), a convolutional neural network (CNN), a recurrent neural network (RNN) or any combination of these standard models.

The environment class ENV_ID may be considered an additional input to the classification model 242, for example an additional neuron or node in the first layer of a neural network. In this case, the environment class ENV_ID determined is provided as input to the AI LOS/NLOS classification model 242. Using the class ENV_ID as additional input to the AI model has the advantage of facilitating integration.

In an alternative embodiment, the environment class ENV-ID can be used to adjust parameters (such as weights) of the classification model 242. For example, it can be used as bias in a neural network working as classifier 242, for example bias of all or some of the neurones/nodes, or be used as a factor for modifying the weight of one or more connections (typically all the connections) of a neural network working as classifier 242. It is therefore possible to weight all or some of the weights of the neural network by the environment class ENV_ID (integer value or not). In this case, the environment class ENV_ID determined is provided as modulation parameter for the AI LOS/NLOS classification model 242.

The LOS/NLOS classifier 242 and the environment classifier 241, if applicable, is trained by supervised learning based on a training data set, providing CIRs and/or extracted characteristics, as well as the corresponding environment class ENV_ID and the LOS/NLOS state. Preferably, any conventional supervised learning method may be used. In embodiments recalled above, unsupervised learning may be used for the environment classifier 241 where the environment classes are not to be pre-defined.

The typical size of the data set varies between 3,000 and 10,000 samples per condition (i.e., per NLOS and ENV_ID condition). In a known manner, this set may be divided into a training set and validation set.

Training may be divided into two steps. Firstly, the environment classifier 241 is trained. Then it is frozen once convergence has been reached, and the LOS/NLOS classifier 242 is then trained.

FIG. 4 shows an embodiment of the classification circuit 24.

In this embodiment, the environment classifier 241 comprises a convolutional neural network CNN 241a cascaded with a multilayer perceptron classifier MLP 241b, the convolutional neural network receiving the CIR as input.

The CNN is advantageously used to identify geometric characteristics in the CIR for high-quality environment classification.

By way of example, the CNN 241a comprises an input layer, two convolutional hidden layers and an output layer. The input layer can have a size corresponding to the number of samples—for example 1016 or 2048—of the CIR or to the number of samples—for example 64 to 256—of a portion of the CIR focused on the energy part of the signal, typically 25% before the peak of the CIR and 75% after. The size of the output layer depends on the input layer and the intermediate layers. The hidden layers can implement up to sixteen convolutional filters/kernels per layer (to produce sixteen or fewer feature maps), with dimensions of between 5 and 11, each accompanied by a pooling layer applying sub-sampling by a factor of 2, for example.

The MLP 241b enables a classification operation, and the class ENV_ID can therefore be obtained. The MLP 241b receives, in addition to the output of the CNN, a first set SET_1 of characteristics extracted from the CIR (by the extraction circuit 23). The set SET_1 is typically only made up of statistical characteristics. Of course, physical characteristics can be used in addition.

The MLP 241b is a multilayer perceptron having, for example, a single hidden layer.

The CNN 241a and the MLP 241b are trained together from the training data set. This enables the CNN, in particular its outputs, to be adapted to the needs of environment classification.

The LOS/NLOS classifier 242 is also a multilayer perceptron having, for example, a single hidden layer. It receives as input the class ENV_ID determined by the classifier 241, the output of the CNN 241a and a second set SET_2 of characteristics extracted from the CIR (by the extraction circuit 23).

The set SET_2 is typically made up of statistical characteristics and physical characteristics. The intersection between SET_1 and SET_2 may or may not be zero. For example, the statistical characteristics may be identical, in whole or in part.

The use of the same CNN 241a for the environment classifier 241 and the LOS/NLOS classifier 242 reduces the level of complexity, in particular the memory requirements of the device 10, 11, 12. This joint use is possible because the CNNs are used to identify geometric characteristics which help classify the signals, whether this is environment classification or LOS/NLOS classification. Of course, it is alternatively possible to use separate CNNs.

As explained above, the MLP 242 (more generally the LOS/NLOS classifier) is trained once the CNN 241a and the MLP 241b have been trained.

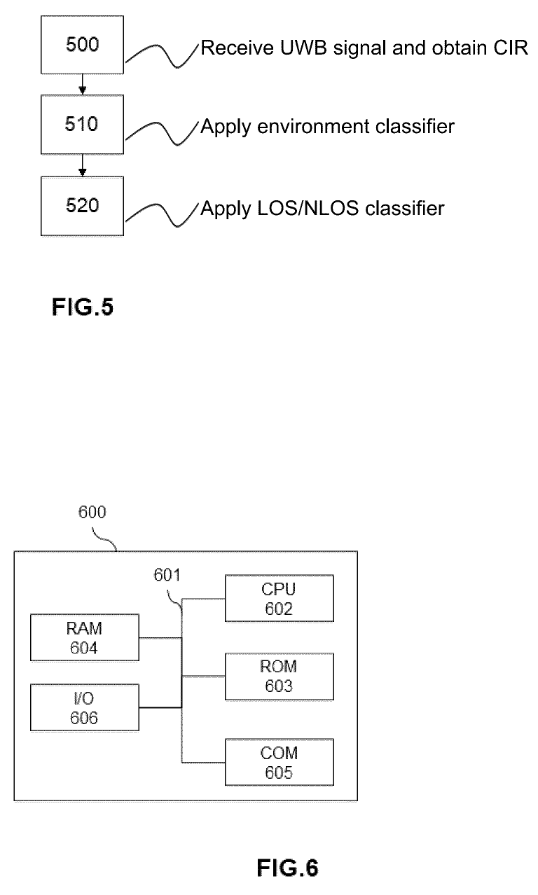

FIG. 5 is a flowchart showing steps of a communication method. If, during UWB ranging operations, two devices (or more, for example 10, 11, 12 in FIG. 1) exchange UWB frames, one or both perform the following steps to obtain ranging measurements.

In step 500, the device receives a UWB radio signal from another device and obtains a channel impulse response (CIR) from the radio signal received. The CIR may be pre-processed to improve the quality thereof for ranging purposes.

In step 510, the device uses the environment classifier 241 to determine an environment class ENV_ID classifying an environment of the electronic device receiving the radio signal. In embodiments described above, this involves running one or more trained AI models, using as input the CIR obtained, possibly via the characteristic extraction circuit 23.

Then in step 520, the device uses the second LOS/NLOS classifier 242 to determine line-of-sight (LOS) or non-line-of-sight (NLOS). This determination is carried out by running a (trained) AI model depending on the CIR (directly and/or via extracted characteristics and/or via the output of the CNN 241b) and the environment class determined.

The LOS or NLOS indication obtained in this way can be provided as input to the ranging circuit 25.

The two-stage classifier as described above advantageously allows the same LOS/NLOS classification model to be used in a wide range of different environments in which the measurement device is progressing. All without having to load a new classification model or retrain the classification model built into the device.

FIG. 6 shows the hardware architecture for a device 10, 11, 12 in FIG. 1. It comprises a communication bus 601 to which the following are preferably connected: one or more central processing circuits 602, such as one or more CPU processors and/or one or more microprocessors; a ROM-type and/or flash-memory-type storage memory 603, for storing computer programs intended to implement all or some of the operations described above; a RAM type random-access memory 604, for storing the executable code of the computer programs, as well as the registers suitable for recording variables and parameters necessary for execution thereof; a communication interface 605, in particular of UWB type for transmitting and receiving UWB radio signals, in particular as part of ranging operations; and one or more inputs/outputs I/O 606 enabling an operator to interact with the computer programs.

The communication bus 601 ensures communication and interoperability between the various elements included in the device 600 or connected thereto.

The central circuit 602 is preferably suitable for controlling and directing the execution of instructions or portions of software code of the computer program(s). When switched on, the program(s) stored in non-volatile memory 603 are transferred/loaded into the random access memory 604, which then contains the executable code of the program(s), as well as registers for storing the variables and parameters required to implement the processes described.

Tests have been carried out using a device in line with the architecture shown in FIG. 4, trained using the training data used in the following three publications: Bregar, et al., “Improving Indoor Localization Using Convolutional Neural Networks on Computationally Restricted Devices”, IEEE Access Volume: 6, 2018, pp. 17429-17441, Fontaine, et al., “Edge Inference for UWB Ranging Error Correction Using Autoencoders”; IEEE Access Volume: 8, 2020, pp. 139143-139155, and Bregar, et al., “Indoor UWB Positioning and Position Tracking Data Set”, Scientific Data volume 10, 2023, Article number: 744; and with a clean set of around 45,000 inputs corresponding to LOS and NLOS situations inside (open-space) and outside (open-air car park).

The CIR and CIR-based characteristics are sufficient to classify environments, which then makes it possible to refine the LOS/NLOS classifier. The characteristics used comprised: energy of the CIR, peak energy, delay mean (MED), delay spread (RMS Delay Spread), standard deviation (STD), signal-to-noise ratio (SNR), skewness coefficient(S) and kurtosis coefficient (K).

The results of these tests were compared with those of a conventional LOS/NLOS classifier trained with the same data, without knowledge of the environment.

The result was significantly better NLOS classification performance with the environment taken into account than the performance of the conventional LOS/NLOS classifier (not sensitive to the environment), of around 10 to 15 pts.

In particular, this resulted in robust environment classification performance, greater than 95%, enabling this information (ENV_ID) to be reliably used by the LOS/NLOS classifier.

Of course, the present disclosure is not limited to the embodiments described above by way of example; it extends to other variants. Other embodiments are possible.

1. An electronic device, comprising:
a communication circuit configured to receive a radio signal and obtain a channel impulse response from the radio signal;
a pre-classification circuit configured to classify an environment of the electronic device receiving the radio signal; and
a processing circuit with an artificial intelligence (AI) line-of-sight (LOS) or non-line-of-sight (NLOS) classification model configured to determine line-of-sight or non-line-of-sight of a communication with the electronic device depending on the CIR and the environment class determined by the pre-classification circuit.

2. The device according to claim 1, wherein the pre-classification circuit comprises an AI environment classification model configured to determine the environment class of the electronic device from the CIR.

3. The device according to claim 1, wherein the pre-classification circuit comprises a convolutional neural network (CNN) cascaded with an artificial intelligence (AI) environment classification model for the electronic device configured to determine the environment class, wherein the CNN receives the CIR as input.

4. The device according to claim 3, wherein the AI environment classification model receives, in addition to output of the CNN, a first set of characteristics extracted from the CIR.

5. The device according to claim 3, wherein the CNN and the AI environment classification model are trained jointly, using a dataset labelling CIRs with environment classes.

6. The device according to claim 3, wherein the LOS/NLOS classification model receives as input output of the CNN and a second set of characteristics extracted from the CIR.

7. The device according to claim 1, wherein the LOS/NLOS classification model is trained once the CNN and the AI environment classification model have been trained.

8. The device according to claim 1, wherein the environment class determined is provided as input to the AI LOS/NLOS classification model.

9. The device according to claim 3, wherein the environment class determined is provided as modulation parameter for the AI LOS/NLOS classification model.

10. The device according to claim 9, wherein the modulation parameter is a bias or a factor for modifying the weight of one or more connections in a neural network forming the AI LOS/NLOS classification model.

11. A method for an electronic device, comprising the following steps:
obtaining a channel impulse response (CIR) from a received radio signal;
determining an environment class classifying an environment of the electronic device receiving the radio signal; and
using a classification model to determine line-of-sight (LOS) or non-line-of-sight (NLOS) of a communication with the electronic device depending on the CIR and the environment class determined.

12. The method according to claim 11, wherein determining the environment class comprises applying an artificial intelligence (AI) environment classification model configured to determine the environment class of the electronic device from the CIR.

13. The method according to claim 11, wherein determining the environment class comprises applying a convolutional neural network (CNN) process cascaded with an artificial intelligence (AI) environment classification model for the electronic device configured to determine the environment class, wherein the CNN receives the CIR as input.

14. The method according to claim 13, wherein the AI environment classification model receives, in addition to output of the CNN, a first set of characteristics extracted from the CIR.

15. The method according to claim 13, further comprising jointly training the CNN and the AI environment classification model, using a dataset labelling CIRs with environment classes.

16. The method according to claim 13, wherein the LOS/NLOS classification model receives as input output of the CNN and a second set of characteristics extracted from the CIR.

17. The method according to claim 13, further comprising training the LOS/NLOS classification model after training the CNN and the AI environment classification model.

18. The method according to claim 11, wherein the environment class determined is provided as input to the AI LOS/NLOS classification model.

19. The method according to claim 11, wherein the environment class determined is provided as modulation parameter for the AI LOS/NLOS classification model.

20. The method according to claim 19, wherein the modulation parameter is a bias or a factor for modifying the weight of one or more connections in a neural network forming the AI LOS/NLOS classification model.
